(19) United States
(12) Patent Application Publication
(10) Pub. No.: US 2020/0052567 A1
(43) Pub. Date: Feb. 13, 2020

(54) METHOD OF MANUFACTURING MAGNET ASSEMBLY, MAGNET ASSEMBLY,VIBRATING MOTOR, AND HAPTIC DEVICE

(71) Applicant: Nidec Seimitsu Corporation, Ueda-shi (JP)

(72) Inventors: Yuuki YAMADA, Kyoto (JP); Yoshiyuki SANO, Kyoto (JP); Takashi MORI, Kyoto (JP)

(21) Appl. No.: 16/505,821

(22) Filed: Jul. 9, 2019

(30) Foreign Application Priority Data
Aug. 8, 2018 (JP) 2018-149095

(51) Int. Cl. H02K 33/18; H01F 27/26; H01F 41/02; B23K 3/08; H02K 41/03; B24B 41/06

(52) U.S. Cl. CPC H02K 33/18; H01F 27/266; B24B 41/06; B23K 3/087; H02K 41/031; H01F 41/0206

(57) ABSTRACT

In a method of manufacturing a first magnet assembly, magnets each including a plating layer on a surface of the magnets are used as a first magnet, a second magnet, and a third magnet. In addition, the first magnet, the second magnet, and the third magnet are disposed in a first direction with same poles facing each other, a frame is brought into contact with the magnets in a second direction, and the frame and the magnets are gripped by a jig. Next, the magnets and the frame are welded to each other. After that, the grip of the jig is released and the jig is separated from the magnets and the frame. Thereafter, an adhesive is applied to the magnets and the frame.

### CROSS REFERENCE TO RELATED APPLICATION

The present invention claims priority under 35 U.S.C. § 119 to Japanese Application No. 2018-149095 filed on Aug. 8, 2018 the entire contents of which are incorporated herein by reference.

### FIELD OF THE INVENTION

The present disclosure relates to a method of manufacturing a magnet assembly, a magnet assembly, a vibrating motor, and a haptic device.

### BACKGROUND

A vibrating motor mounted on any of various devices, such as a smart phone, has a coil disposed inside a magnetic field generated by a magnetic field generator, and moves the magnetic field generator and the coil relative to each other by controlling energization of the coil. Japanese Unexamined Patent Application Publication No. 2016-163366 describes a magnetic field generator of such a vibrating motor. The magnetic field generator includes a magnet assembly in which a plurality of magnets are fixed to a frame made of nonmagnetic metal. In the magnet assembly, an adhesive is used to fix the magnets and the frame to each other.

When manufacturing a magnet assembly, first, a magnet and a frame are disposed in a predetermined positional relationship and are gripped by a jig. Next, an adhesive is applied to the magnet and the frame. The adhesive is then cured. After that, the grip by the jig is released and the magnet and the frame are separated from the jig.

When applying the adhesive to the magnet and the frame, the adhesive may adhere to the jig. If the adhesive adheres to the jig, it is necessary to remove the adhesive from the jig before starting the manufacture of the next magnet assembly. Therefore, there is a problem that the manufacture of the magnet assembly is more complicated and time consuming.

### SUMMARY

Example embodiments of the present disclosure provide methods of manufacturing magnet assemblies in each of which an adhesive does not adhere to a jig when fixing a magnet and a frame to each other. Example embodiments of the present disclosure also provide magnet assemblies manufactured by such manufacturing methods. In addition, example embodiments of the present disclosure provide vibrating motors provided with such magnet assemblies.

An example embodiment of the present disclosure relates to a method of manufacturing a magnet assembly in which a magnet is fixed to a frame made of a metal. The method includes using a magnet including a plating layer on a surface of the magnet as the magnet, bringing the frame and the magnet into contact with each other and gripping the frame and the magnet with a jig, welding the magnet and the frame to each other, releasing the grip of the jig to separate the jig from the magnet and the frame, and applying an adhesive to the magnet and the frame.

In addition, an example embodiment of the present disclosure provides a method of manufacturing a magnet assembly in which a first magnet, a second magnet, and a third magnet are fixed to a frame made of a metal. The method including using magnets including a plating layer on a surface of the magnets as the first magnet, the second magnet, and the third magnet, disposing the first magnet, the second magnet, and the third magnet in a first direction determined in advance with poles of an identical type adjacent to each other, bringing the frame into contact with the first magnet, the second magnet, and the third magnet from a second direction intersecting the first direction and gripping the frame, the first magnet, the second magnet, and the third magnet with a jig, welding the first magnet and the frame to each other, welding the second magnet and the frame to each other, and welding the third magnet and the frame to each other, releasing the grip of the jig to separate the jig from the first magnet, the second magnet, the third magnet, and the frame, and applying an adhesive to the first magnet, the second magnet, the third magnet, and the frame.

Next, a magnet assembly of an example embodiment of the present disclosure includes a magnet, a frame that is made of a metal and that contacts the magnet from a predetermined direction, an adhesive layer provided between the frame and the magnet, in which the magnet includes a plating layer on a surface of the magnet, and in which the frame is provided with a welding mark at a position overlapping the magnet when viewed from the predetermined direction.

In addition, a magnet assembly of an example embodiment of the present disclosure includes a first magnet, a second magnet, and a third magnet disposed in a first direction determined in advance, a frame that is made of a metal and that contacts the first magnet, the second magnet, and the third magnet from a second direction intersecting the first direction, and an adhesive layer provided between the first magnet and the frame, between the second magnet and the frame, and between the third magnet and the frame. Each of the first magnet, the second magnet, and the third magnet includes a plating layer on a surface of the first magnet, the second magnet, and the third magnet, in which same poles of the first magnet, the second magnet, and the third magnet are adjacent to each other, and in which the frame includes, when viewed from the second direction, a first welding mark at a position overlapping the first magnet, a second welding mark at a position overlapping the second magnet, and a third welding mark at a position overlapping the third magnet.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a perspective view of a vibrating motor according to an example embodiment of the present disclosure as viewed from a cover side.

FIG. 2 is an exploded perspective view of the vibrating motor of FIG. 1.

FIG. 3 is a plan view of the vibrating motor with a cover omitted.

FIG. 4 is an exploded perspective view of the vibrating motor with the cover omitted.

FIG. 5 is an explanatory view of an arrangement example of each magnet in a first magnet assembly and a second magnet assembly according to an example embodiment of the present disclosure.

FIG. 6 is a side view of the vibrator assembly according to an example embodiment of the present disclosure as viewed from a first magnet assembly side.

FIG. 7 is a perspective view of the first magnet assembly as viewed from a frame side.

FIG. 8 is a perspective view of the first magnet assembly as viewed from a magnet side.

FIG. 9 is a flowchart of a method of manufacturing the first magnet assembly.

FIG. 10 is a schematic view of a haptic device assembly according to an example embodiment of the present disclosure.

### DETAILED DESCRIPTION

Hereinafter, example embodiments of a vibrating motor, a magnet assembly, a method of manufacturing a magnet assembly, and a haptic device to which the present disclosure is applied will be described with reference to the drawings.

### Vibrating Motor

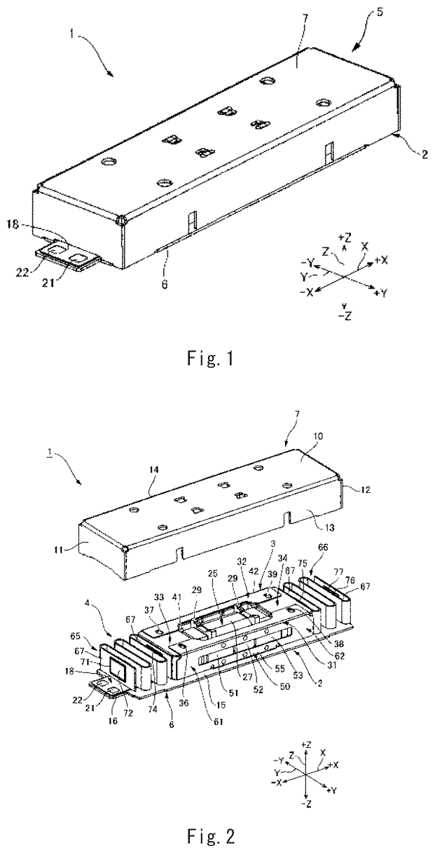

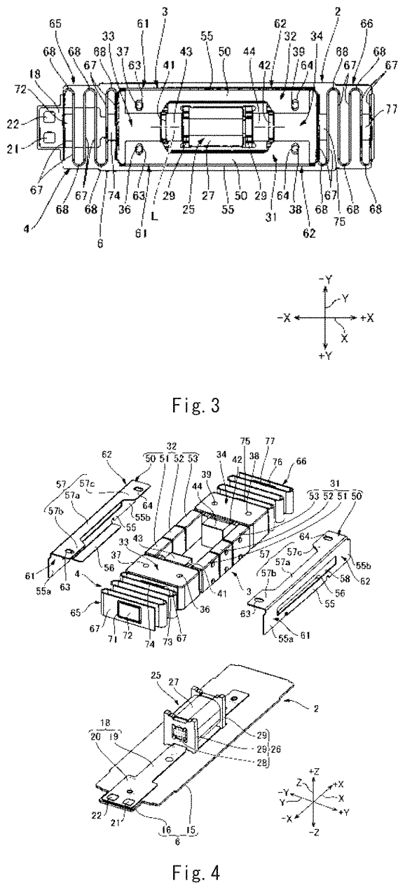

FIG. 1 is a perspective view of a vibrating motor to which the present disclosure is applied as viewed from a cover side. FIG. 2 is an exploded perspective view of the vibrating motor. FIG. 3 is a plan view of a vibrating motor 1 with a cover 7 omitted. The vibrating motor 1 reciprocates a vibrating body 3 with respect to a stationary body 2 to generate vibration.

As illustrated in FIG. 1, the vibrating motor 1 has a casing 5 having a rectangular parallelepiped shape on the whole. The casing 5 includes a base plate 6, which is flat-plate shaped, and the cover 7, which is box-shaped, placed on the base plate 6. As illustrated in FIGS. 2 and 3, the vibrating body 3 and a support mechanism 4 that supports the vibrating body 3 so as to allow reciprocation of the vibrating body 3 are housed in the casing 5 partitioned by the base plate 6 and the cover 7. Here, the casing 5 is a portion of the stationary body 2. The stationary body 2 supports the vibrating body 3 via the support mechanism 4.

In the following description, the long-side direction of the vibrating motor 1 will be referred to as a first direction X. The short-side direction of the vibrating motor 1 will be referred to as a second direction Y. The first direction X and the second direction Y are perpendicular to each other. In addition, a direction perpendicular to the first direction X and the second direction Y will be referred to as a third direction Z.

Furthermore, one side in the first direction X will be referred to as a −X direction side and the other side will be referred to as a +X direction side. One side of the second direction Y will be referred to as a −Y direction side and the other side will be referred to as a +Y direction side. One side of the third direction Z will be referred to as a −Z direction side and the other side will be referred to as a +Z direction side. Here, the X direction is a movement direction in which the vibrating body 3 reciprocates. The Z direction is the stacking direction in which the base plate 6 and the cover 7 are stacked. The −Z direction side is the side where the base plate 6 is located, and the +Z direction side is the side where the cover 7 is located.

### Stationary Body

FIG. 4 is an exploded perspective view of the vibrating motor 1 with the cover 7 omitted. As illustrated in FIG. 2, the cover 7 of the casing 5 includes an end plate 10 that is rectangular and that is located at the +Z direction end, a first side plate portion 11 extending in the −Z direction from the −X direction end edge of the end plate 10, and a second side plate portion 12 extending in the −Z direction from the +X direction end edge of the end plate 10. In addition, the cover 7 includes a third side plate portion 13 extending in the −Z direction from the +Y direction end edge of the end plate 10 and a fourth side plate portion 14 extending in the −Z direction from the −Y direction end edge of the end plate 10.

As illustrated in FIG. 4, the base plate 6 includes a base portion 15, which is rectangular and covered by the cover 7, and a base protruding portion 16 protruding from the base portion 15 in the −X direction. A substrate 18 is fixed to a +Z direction surface of the base plate 6. The substrate 18 is a flexible printed substrate or a rigid substrate. In the present example, the substrate 18 is a flexible printed substrate. The substrate 18 includes a base portion 19 fixed to the base portion 15 of the base plate 6, and an extending portion 20 extending from the base portion 19 in the −X direction and reaching the base protruding portion 16. The extending portion 20 is wider in the Y direction than the base portion 19. A first terminal portion 21 and a second terminal portion 22 are provided at the tip end portion of the extending portion 20. As illustrated in FIG. 1, the first terminal portion 21 and the second terminal portion 22 are exposed to the outside of the casing 5.

As illustrated in FIG. 4, a coil portion 25 is fixed at the center of the base portion 15. The coil portion 25 includes a core 26 made of a magnetic material such as iron and a coil 27 wound around the core 26. The core 26 includes a core portion 28 extending in the first direction X, and a pair of flange portions 29 fixed to both first direction X end portions of the core portion 28. The core portion 28 is formed by stacking thin plates made of a magnetic material such as iron. Each of the flange portions 29 is an annular plate member made of a magnetic material such as iron. The −X direction end portion of the core portion 28 is fitted in a center hole of one of the flange portions 29 located on the −X direction side. The +X direction end portion of the core portion 28 is fitted in a center hole of the other one of the flange portions 29 located on the +X direction side. As illustrated in FIG. 3, an axis L of the coil 27 is oriented in the first direction X.

The coil 27 is wound around the outer periphery of the core portion 28 between the pair of flange portions 29. One end and the other end of the coil 27 are each electrically connected to the base portion 19 of the substrate 18. Consequently, one end of the coil 27 is electrically connected to the first terminal portion 21 via a wiring pattern provided on the substrate 18. In addition, the other end of the coil 27 is electrically connected to the second terminal portion 22 via a wiring pattern provided on the substrate 18. The coil portion 25 is fixed to the base plate 6 by fixing each of the pair of the flange portions 29 to the base plate 6. The substrate 18 and the coil portion 25 form the stationary body 2 together with the base plate 6 and the cover 7.

### Vibrating Body

As illustrated in FIG. 2 and FIG. 3, the vibrating body 3 surrounds the coil portion 25 from the first direction X and the second direction Y. The vibrating body 3 includes a first magnet assembly 31 disposed on the +Y direction side of the coil portion 25 and a second magnet assembly 32 disposed on the −Y direction side of the coil portion 25. In addition, the vibrating body 3 further includes a first weight 33 disposed on the −X direction side of the coil portion 25 and a second weight 34 disposed on the +X direction side of the coil portion 25. The first weight 33 connects a −X direction end portion of the first magnet assembly 31 and a −X direction end portion of the second magnet assembly 32. The second weight 34 connects a +X direction end portion of the first magnet assembly 31 and a +X direction end portion of the second magnet assembly 32.

The first weight 33 includes two first locking protrusions 36 and 37 disposed in the Y direction on a +Z direction end surface thereof. The second weight 34 includes two second locking protrusions 38 and 39 disposed in the Y direction on a +Z direction end surface thereof. A first magnetic plate 41 is attached to a +X direction end surface of the first weight 33 facing the coil portion 25 in the first direction X. A second magnetic plate 42 is attached to a −X direction end surface of the second weight 34 facing the coil portion 25 in the first direction X. A first damper member 43 is disposed between the coil portion 25 and the first magnetic plate 41 in the first direction X. A second damper member 44 is disposed between the coil portion 25 and the second magnetic plate 42 in the first direction X. The first damper member 43 and the second damper member 44 are each elastically deformable in the first direction X.

The first magnet assembly 31 and the second magnet assembly 32 are symmetrical with respect to an imaginary plane extending in the first direction X and the third direction Z, including the axis L of the coil portion 25. As illustrated in FIG. 2, the first magnet assembly 31 and the second magnet assembly 32 each have a frame 50 extending in the first direction X and a first magnet 51, a second magnet 52 and a third magnet 53 that are fixed to the frame 50. The frame 50 is made of a metal. In the present example, the frame 50 is made of stainless steel. In addition, in the present example, the frame 50 is nonmagnetic.

The first magnet 51, the second magnet 52 and the third magnet 53 are sintered magnets. In addition, the first magnet 51, the second magnet 52, and the third magnet 53 are magnets with a plating layer on the surface thereof. In other words, the surfaces of the first magnet 51, the second magnet 52 and the third magnet 53 are covered with a plating layer. Further, on the surface of a typical magnet, a nickel plating layer is provided as a coating layer for rust prevention. The plating layer may be a zinc plating layer, a chromium plating layer, a copper plating layer, a tin plating layer, a gold plating layer, a silver plating layer, a palladium plating layer, or a cobalt plating layer.

The first magnet 51, the second magnet 52, and the third magnet 53 are fixed at a first direction X center of the frame 50. As illustrated in FIG. 4, the first magnet 51, the second magnet 52, and the third magnet 53 are arranged in this order from the −X direction side to the +X direction side. The frame 50 comes into contact with the first magnet 51, the second magnet 52, and the third magnet 53 from a second direction Y perpendicular to the first direction X. That is, the frame 50 of the first magnet assembly 31 includes a frame main body 55 that comes into contact with the first magnet 51, the second magnet 52, and the third magnet 53 from the +Y direction side. In addition, the frame 50 of the second magnet assembly 32 includes the frame main body 55 that comes into contact with the first magnet 51, the second magnet 52, and the third magnet 53 from the −Y direction side.

Here, the frame 50 includes a first-weight fixing portion 61 extending in the −X direction farther than the first magnet 51, and a second-weight fixing portion 62 extending in the +X direction farther than the third magnet 53. The first-weight fixing portion 61 includes a first locking hole 63 in which one of the two first locking protrusions 36 and 37 of the first weight 33 is locked. The second-weight fixing portion 62 includes a second locking hole 64 in which one of the two second locking protrusions 38 and 39 of the second weight 34 is locked. That is, as illustrated in FIG. 3, the first-weight fixing portion 61 of the frame 50 of the first magnet assembly 31 includes the first locking hole 63 in which the first locking protrusion 36 located in the +Y direction among the two first locking protrusions 36 and 37 of the first weight 33 is locked. The first-weight fixing portion 61 of the frame 50 of the second magnet assembly 32 includes the first locking hole 63 in which the first locking protrusion 37 located in the −Y direction among the two first locking protrusions 36 and 37 of the first weight 33 is locked. In addition, the second-weight fixing portion 62 of the frame 50 of the first magnet assembly 31 includes the second locking hole 64 in which the second locking protrusion 38 located in the +Y direction among the two second locking protrusions 38 and 39 of the second weight 34 is locked. The second-weight fixing portion 62 of the frame 50 of the second magnet assembly 32 includes the second locking hole 64 in which the second locking protrusion 39 located in the −Y direction among the two second locking protrusions 38 and 39 of the second weight 34 is locked.

The first weight 33, with the first locking protrusion 36 locked in the first locking hole 63 of the first magnet assembly 31 and the first locking protrusion 37 locked in the first locking hole 63 of the second magnet assembly 32, is interposed between the first-weight fixing portion 61 of the first magnet assembly 31 and the first-weight fixing portion 61 of the second magnet assembly 32. The second weight 34, with the second locking protrusion 38 locked in the second locking hole 64 of the first magnet assembly 31 and the second locking protrusion 39 locked in the second locking hole 64 of the second magnet assembly 32, is interposed between the second-weight fixing portion 62 of the first magnet assembly 31 and the second-weight fixing portion 62 of the second magnet assembly 32.

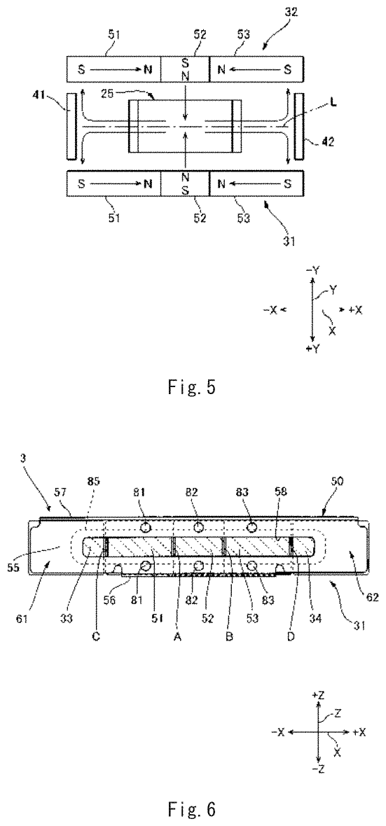

FIG. 5 is an explanatory view of an arrangement example of each magnet in the first magnet assembly 31 and the second magnet assembly 32. As illustrated in FIG. 5, in each of the first magnet assembly 31 and the second magnet assembly 32, the first magnet 51, the second magnet 52, and the third magnet 53 are arranged with poles of the same type adjacent to each other.

More specifically, the first magnet 51 is disposed with the S pole oriented in the −X direction and the N pole oriented in the +X direction. The second magnet 52 is disposed with the N pole facing the coil portion 25 in the second direction Y and the S pole facing the opposite side to the coil portion 25. That is, in the first magnet assembly 31, the second magnet 52 is disposed with the N pole oriented in the −Y direction and the S pole oriented in the +Y direction. In the second magnet assembly 32, the second magnet 52 is disposed with the N pole oriented in the +Y direction and the S pole oriented in the −Y direction. The third magnet 53 is disposed with the N pole oriented in the −X direction and the S pole oriented in the +X direction. In the first magnet 51 and the third magnet 53, the directions of the magnetic flux are directed toward the second magnet 52. In the second magnet 52, the direction of the magnetic flux is directed toward the coil portion 25. The array structure of such magnets is called a Halbach array structure.

In this example, by adopting a Halbach array structure as the array structure of the first magnet 51, the second magnet 52, and the third magnet 53, a magnetic circuit is formed in the vibrating body 3 in the direction of magnetic flux from the center of each of the first magnet assembly 31 and the second magnet assembly 32 returning to both first direction X ends via the coil portion 25. Accordingly, as illustrated by the arrows in FIG. 5, the magnetic flux generated by each of the first magnet assembly 31 and the second magnet assembly 32 can be concentrated on the coil portion 25. In addition, in this example, the first magnetic plate 41 is fixed to the first weight 33 so that the first magnetic plate 41 faces the coil portion 25 from the −X direction side. Furthermore, the second magnetic plate 42 is fixed to the second weight 34 so that the second magnetic plate 42 faces the coil portion 25 from the +X direction side. Therefore, the leakage of magnetic flux can be suppressed.

### Support Mechanism

Next, the support mechanism 4 supports the vibrating body 3 so as to allow the vibrating body 3 to reciprocate in the X-axis direction. As illustrated in FIG. 2, the support mechanism 4 includes a first elastic member 65 disposed on the −X direction side of the vibrating body 3 and a second elastic member 66 disposed on the +X direction side of the vibrating body 3. The first elastic member 65 and the second elastic member 66 are plate springs. The first elastic member 65 and the second elastic member 66 have corresponding configurations.

The first elastic member 65 and the second elastic member 66 extend in the first direction X while repeatedly meandering in the second direction Y. As illustrated in FIG. 3, each of the first elastic member 65 and the second elastic member 66 includes a plurality of flat plate portions 67 spreading in the second direction Y and the third direction Z and a plurality of curved plate portions 68 that are curved between the flat plate portions 67 adjacent in the first direction X and that connect the ends of every two adjacent ones of the flat plate portions 67. In the present example, each of the first elastic member 65 and the second elastic member 66 includes six flat plate portions 67 and five curved plate portions 68.

In the first elastic member 65, a first one of the flat plate portions 67 located at the −X direction end is fixed to the first side plate portion 11 of the cover 7. Here, as illustrated in FIG. 4, the first one of the flat plate portions 67 is provided with an opening portion 71, which is rectangular. A third damper member 72, which has a rectangular parallelepiped shape, is disposed inside the opening portion 71. The third damper member 72 is fixed to the first side plate portion 11 by double-sided tape. The +X direction end surface of the third damper member 72 is in contact with the flat plate portion 67 located next to the first one of the flat plate portions 67 in the +X direction. In addition, in the first elastic member 65, a second one of the flat plate portions 67 located at the +X direction end is fixed to the first weight 33. The second one of the flat plate portions 67 is provided with an opening portion 73, which is rectangular. A fourth damper member 74, which has a rectangular parallelepiped shape, is disposed inside the opening portion 73. The fourth damper member 74 is fixed to the first weight 33 by double-sided tape. The −X direction end surface of the fourth damper member 74 is in contact with the flat plate portion 67 located next to the second one of the flat plate portions 67 in the −X direction.

In the second elastic member 66, a first one of the flat plate portions 67 located at the −X direction end is fixed to the second weight 34. Here, the first one of the flat plate portions 67 is provided with a rectangular opening portion similarly to the first elastic member 65. As illustrated in FIGS. 2 and 3, a fifth damper member 75, which has a rectangular parallelepiped shape, is disposed inside the opening portion of the first one of the flat plate portions 67. The fifth damper member 75 is fixed to the second weight 34 by double-sided tape. The +X direction end surface of the fifth damper member 75 is in contact with the flat plate portion 67 located next to the first one of the flat plate portions 67 in the +X direction. In addition, in the second elastic member 66, a second one of the flat plate portions 67 located at the +X direction end is fixed to the second side plate portion 12 of the cover 7. The second one of the flat plate portions 67 is provided with an opening portion 76, which is rectangular. A sixth damper member 77, which has a rectangular parallelepiped shape, is disposed inside the opening portion 76. The sixth damper member 77 is fixed to the second side plate portion 12 by double-sided tape. The −X direction end surface of the sixth damper member 77 is in contact with the flat plate portion 67 located next to the second one of the flat plate portions 67 in the −X direction.

The third damper member 72, the fourth damper member 74, the fifth damper member 75, and the sixth damper member 77 are elastically deformable in the first direction X. By providing the support mechanism 4 with the third damper member 72 and the fourth damper member 74 for the first elastic member 65, and the fifth damper member 75 and the sixth damper member 77 for the second elastic member 66, vibration damping of the vibrating body 3 can be enhanced to ensure stable vibration. In addition, by providing the support mechanism 4 with the third damper member 72, the fourth damper member 74, the fifth damper member 75, and the sixth damper member 77, it is possible to suppress the first elastic member 65 and the second elastic member 66 from bending in the third direction Z. As a result, when the vibrating body 3 reciprocates, contact with the cover 7 can be prevented or suppressed.

### Operation of Vibrating Motor

When driving the vibrating motor 1, power is supplied to the coil portion 25 via the first terminal portion 21 and the second terminal portion 22. In the present example, an alternating current is supplied to the coil portion 25. When an alternating current is supplied to the coil portion 25, the coil portion 25 periodically switches between a state of generating an N pole in the −X direction and an S pole in the +X direction and a state of generating an S pole in the −X direction and an N pole in the +X direction. That is, in the magnetic circuit of FIG. 5 formed by the first magnet assembly 31 and the second magnet assembly 32 of the vibrating body 3, the coil portion 25 periodically reverses the polarities at both first direction X ends. Consequently, the vibrating body 3 reciprocates in the X-axis direction.

### Details of Magnet Assembly

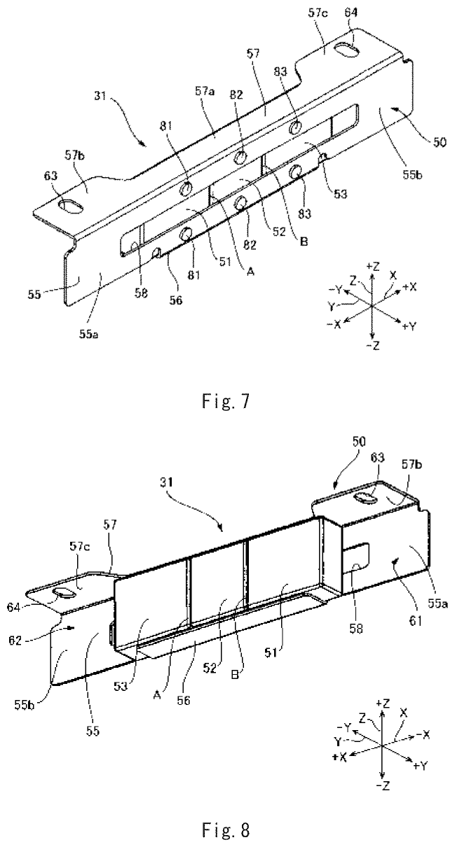

Next, the first magnet assembly 31 will be described in detail. FIG. 6 is a side view of the vibrating body 3 as viewed from the first magnet assembly 31 side. FIG. 7 is a perspective view of the first magnet assembly 31 as viewed from the +Y direction side in the +Z direction. FIG. 8 is a perspective view of the first magnet assembly 31 as viewed from the −Y direction side in the −Z direction. Further, since the first magnet assembly 31 has a structure corresponding to the second magnet assembly 32, the first magnet assembly 31 is described and detailed description of the second magnet assembly 32 is omitted.

As illustrated in FIG. 6, the frame 50 of the first magnet assembly 31 includes the frame main body 55 that is plate-like and that comes into contact with the first magnet 51, the second magnet 52, and the third magnet 53 from the +Y direction. The first magnet 51, the second magnet 52 and the third magnet 53 contact a first direction X center portion of the frame main body 55. Therefore, as illustrated in FIGS. 7 and 8, the frame main body 55 includes a one-side extending portion 55a extending in the −X direction farther than the first magnet 51 and an other-side extending portion 55b extending in the +X direction farther than the third magnet 53. In addition, as illustrated in FIG. 8, the frame 50 is provided with a first protruding portion 56 that protrudes in the −Y direction from a −Z direction end edge of an X direction center portion of the frame main body 55. The first protruding portion 56 is plate-shaped and extends in the Y direction with a constant width. The first protruding portion 56 comes into contact with the first magnet 51, the second magnet 52, and the third magnet 53 from the −Z direction side.

Furthermore, as illustrated in FIG. 7, the frame 50 includes a second protruding portion 57 that protrudes in the −Y direction from the +Z direction end edge of the frame main body 55. The second protruding portion 57 is plate-shaped and extends in the Y direction. The second protruding portion 57 includes a center portion 57a extending in the Y direction with a constant width, a one-side wide portion 57b which protrudes in the −Y direction farther than the center portion 57a in the −X direction of the center portion 57a, and an other-side wide portion 57c which protrudes in the −Y direction farther than the center portion 57a in the +X direction of the center portion 57a. The first locking hole 63 is provided in the one-side wide portion 57b. The second locking hole 64 is provided in the other-side wide portion 57c. The center portion 57a faces the first protruding portion 56 in the Z direction. The center portion 57a comes into contact with the first magnet 51, the second magnet 52, and the third magnet 53 from the +Z direction side.

The one-side wide portion 57b and the one-side extending portion 55a of the frame main body 55 form the first-weight fixing portion 61. The other-side wide portion 57c and the other-side extending portion 55b of the frame main body 55 form the second-weight fixing portion 62. The first-weight fixing portion 61 holds the +Y direction end portion of the first weight 33. The second-weight fixing portion 62 holds the +Y direction end portion of the second weight 34.

Here, as illustrated in FIG. 6, the frame main body 55 includes, in the middle in the Z direction, an opening portion 58 extending in the Y direction with a constant width. The opening portion 58 is a hole provided with an inner peripheral wall surface having the thickness of the frame main body 55. The opening portion 58 extends over a first contact position A where the first magnet 51 and the second magnet 52 are in contact with each other and a second contact position B where the second magnet 52 and the third magnet 53 are in contact with each other. In the present example, the opening portion 58 extends over a first gap position C where a gap formed between the first magnet 51 and the first weight 33 in the Y direction is located, the first contact position A, the second contact position B, and a second gap position D at which a gap formed between the third magnet 53 and the second weight 34 in the Y direction is located. Therefore, the first weight 33, the first magnet 51, the second magnet 52, the third magnet 53, and the second weight 34 are partially exposed from the opening portion 58.

In addition, the frame main body 55, when viewed from the +Y direction, includes first welding marks 81 at positions overlapping the first magnet 51 and second welding marks 82 at positions overlapping the second magnet 52, and third welding marks 83 at positions overlapping the third magnet 53. The first welding marks 81 are provided on either side of the opening portion 58 in the third direction Z. The second welding marks 82 are provided on either side of the opening portion 58 in the third direction Z. The third welding marks 83 are provided on either side of the opening portion 58 in the third direction Z. That is, the first magnet 51 is welded to the frame main body 55 at positions where the first welding marks 81 are formed. In addition, the second magnet 52 is welded to the frame main body 55 at positions where the second welding marks 82 are formed. The third magnet 53 is welded to the frame main body 55 at positions where the third welding marks 83 are formed.

Furthermore, as illustrated in FIG. 6, the first magnet assembly 31 includes an adhesive layer 85 that covers the opening portion 58. Here, the adhesive forming the adhesive layer 85 penetrates between the first magnet 51 and the frame 50, between the second magnet 52 and the frame 50, and between the third magnet 53 and the frame 50 and adheres between these elements. Therefore, the adhesive layer 85 is also provided between the first magnet 51 and the frame 50, between the second magnet 52 and the frame 50, and between the third magnet 53 and the frame 50. In addition, the adhesive forming the adhesive layer 85 penetrates between the first magnet 51 and the second magnet 52 and between the second magnet 52 and the third magnet 53 and adheres between these magnets. Therefore, the adhesive layer 85 is also provided between the first magnet 51 and the second magnet 52 and between the second magnet 52 and the third magnet 53.

In addition, in this example, the adhesive forming the adhesive layer 85 penetrates between the first weight 33 and the frame 50, a gap between the first magnet 51 and the first weight 33, between the second weight 34 and the frame 50, and a gap between the third magnet 53 and the second weight 34 and adheres between these elements. Therefore, the adhesive layer 85 is formed in between the first weight 33 and the frame 50, the gap between the first magnet 51 and the first weight 33, between the second weight 34 and the frame 50, and the gap between the third magnet 53 and the second weight 34.

Further, the adhesive is an adhesive suitable for adhering metal to metal. The adhesive is, for example, an epoxy-resin-based adhesive, a silicone-resin-based adhesive, an acrylic-resin-based adhesive, a urethane-resin-based adhesive, or a phenol-resin-based adhesive.

### Method of Manufacturing Magnet Assembly

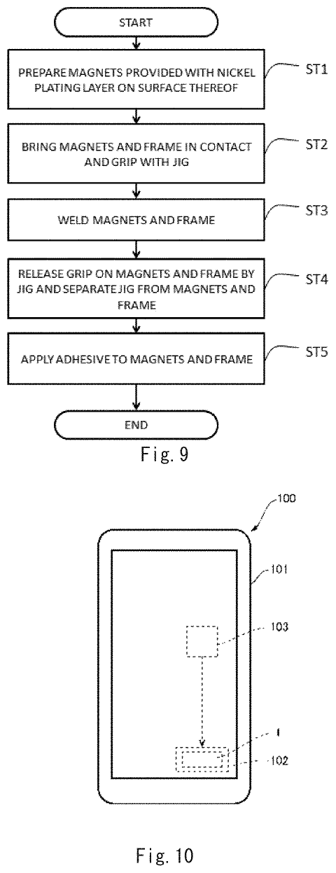

Next, with reference to FIG. 9, the method of manufacturing each of the first magnet assembly 31 and the second magnet assembly 32 is demonstrated. FIG. 9 is a flowchart of a method of manufacturing the first magnet assembly 31. Further, since the first magnet assembly 31 and the second magnet assembly 32 are the same, only the method of manufacturing the first magnet assembly 31 will be described.

In the method of manufacturing the first magnet assembly 31, first, magnets provided with a nickel plating layer on the surface thereof are used as the first magnet 51, the second magnet 52, and the third magnet 53 (step ST1). Next, the first magnet 51, the second magnet 52, and the third magnet 53 are disposed in the first direction X with poles of the same type adjacent to each other. In addition, the frame main body 55 of the frame 50 is brought into contact with the first magnet 51, the second magnet 52, and the third magnet 53 from the +Y direction. In addition, the first protruding portion 56 of the frame 50 is brought into contact with the first magnet 51, the second magnet 52, and the third magnet 53 from the −Z direction, and the center portion 57a of the second protruding portion 57 of the frame 50 is brought into contact with the first magnet 51, the second magnet 52, and the third magnet 53 from the +Z direction. Then, in this state, the frame 50, the first magnet 51, the second magnet 52, and the third magnet 53 are gripped by a jig (step ST2).

Here, since the first magnet 51, the second magnet 52, and the third magnet 53 have poles of the same type disposed adjacent to each other, the first magnet 51, the second magnet 52, and the third magnet 53 repel each other. Therefore, in step ST2, if the frame 50, the first magnet 51, the second magnet 52, and the third magnet 53 are not gripped by a jig, it is not possible to bring all of the first magnet 51, the second magnet 52, and the third magnet 53 into contact with the frame 50.

Next, welding of the first magnet 51 and the frame 50, welding of the second magnet 52 and the frame 50, and welding of the third magnet 53 and the frame 50 are performed (step ST3). In the present example, the welding is laser welding. The welding is performed on the frame main body 55 from the side opposite to the first magnet 51, the second magnet 52, and the third magnet 53. The welding points, when the frame main body 55 is viewed from the +Y direction, are provided at positions overlapping the first magnet 51, positions overlapping the second magnet 52, and positions overlapping the third magnet 53. In this example, at positions overlapping the first magnet 51, welding points are provided at two positions on either side of the opening portion 58 in the third direction Z. Similarly, at positions overlapping the second magnet 52 of the frame main body 55, welding points are provided at two positions on either side of the opening portion 58 in the third direction Z. In addition, at positions overlapping the third magnet 53 of the frame main body 55, welding points are provided at two positions on either side of the opening portion 58 in the third direction Z.

Here, in the first magnet assembly 31, the frame 50 and the first magnet 51, the second magnet 52, and the third magnet 53 are fixed to each other by the adhesive layer 85. Therefore, the fixing by welding between the frame 50 and the first magnet 51, the second magnet 52, and the third magnet 53 in step ST3 can be temporary fixing. In other words, fixing by welding between the frame 50 and the first magnet 51, the second magnet 52, and the third magnet 53 should be performed with a smaller amount of heat than in the case of fixing the frame 50 with the first magnet 51, the second magnet 52, and the third magnet 53 by welding only. As a result, since the first magnet 51, the second magnet 52, and the third magnet 53 can be prevented or suppressed from being exposed to a high temperature for a long time, thermal demagnetization of the first magnet 51, the second magnet 52, and the third magnet 53 can be prevented or suppressed.

In the welding of the first magnet 51 and the frame 50, the nickel of the nickel plating layer of the first magnet 51 and the metal of the base material of the frame 50 are fused to join the first magnet 51 and the frame 50 to each other. Similarly, in the welding of the second magnet 52 and the frame 50, the nickel of the nickel plating layer of the second magnet 52 and the metal of the base material of the frame 50 are fused to join the second magnet 52 and the frame 50 to each other. In addition, in the welding of the third magnet 53 and the frame 50, the nickel of the nickel plating layer of the third magnet 53 and the metal of the base material of the frame 50 are fused to join the third magnet 53 and the frame 50 to each other. Here, when the first magnet 51 and the frame 50 are to be welded to each other, as illustrated in FIGS. 6 and 7, the first welding marks 81 are formed on the frame main body 55. Similarly, when the second magnet 52 and the frame 50 are to be welded to each other, the second welding marks 82 are formed on the frame 50. In addition, when the third magnet 53 and the frame 50 are to be welded to each other, the third welding marks 83 are formed on the frame 50.

Next, the grip on the first magnet 51, the second magnet 52, the third magnet 53 and the frame 50 by the jig is released. Then, the jig is separated from the first magnet 51, the second magnet 52, the third magnet 53, and the frame 50 (step ST4). Here, since the first magnet 51, the second magnet 52, and the third magnet 53 are arranged with the same poles adjacent to each other, the first magnet 51, the second magnet 52, and the third magnet 53 repel each other. However, each of the first magnet 51, the second magnet 52, and the third magnet 53 is fixed to the frame 50 by welding. Therefore, even when the grip by the jig is released, the state in which the first magnet 51, the second magnet 52, and the third magnet 53 are in contact with the frame 50 is maintained.

Thereafter, an adhesive is applied to the first magnet 51, the second magnet 52, the third magnet 53, and the frame 50 (step ST5).

Further, in this example, when manufacturing the first magnet assembly 31, a fixing operation of fixing the first weight 33 and the second weight 34 to the first magnet assembly 31 while holding the first weight 33 and the second weight 34 on the frame 50 is performed. Therefore, between step ST3 and step ST5, the first locking protrusion 36 of the first weight 33 is locked to the first locking hole 63 of the frame 50 to support the first weight 33 on the frame 50. In addition, the second locking protrusion 38 of the second weight 34 is locked in the second locking hole 64 of the frame 50 to cause the frame 50 to support the second weight 34.

In step ST5, an adhesive is applied to the entire area inside the opening portion 58 provided in the frame main body 55. Consequently, the adhesive penetrates between the first magnet 51 and the frame 50, between the second magnet 52 and the frame 50, and between the third magnet 53 and the frame 50. That is, the adhesive penetrates, from the opening edge of the opening portion 58 in the frame main body 55, between the frame main body 55 and the first magnet 51, between the frame main body 55 and the second magnet 52, and between the frame main body 55 and the third magnet 53. In addition, the adhesive penetrates between the first magnet 51 and the second magnet 52 and between the second magnet 52 and the third magnet 53. Furthermore, the adhesive penetrates the gap between the first weight 33 and the frame 50, between the first magnet 51 and the first weight 33, between the second weight 34 and the frame 50, and the gap between the third magnet 53 and the second weight 34. Here, the opening portion 58 is a hole provided with an inner peripheral wall surface having the thickness of the frame main body 55. Thus, the opening portion 58 functions as an adhesive reservoir when the adhesive is applied. Thus, the adhesive can be prevented from flowing out to unintended locations.

Thereafter, when the adhesive cures, the adhesive layer 85 is formed. Thus, the adhesive layer 85 is provided on the surfaces of the first weight 33, the first magnet 51, the second magnet 52, the third magnet 53, and the second weight 34 in the region exposed from the opening portion 58. In addition, the adhesive layer 85 is provided between the first magnet 51 and the frame 50, between the second magnet 52 and the frame 50, and between the third magnet 53 and the frame 50. Furthermore, the adhesive layer 85 is provided between the first magnet 51 and the second magnet 52 and between the second magnet 52 and the third magnet 53. In addition, the adhesive layer 85 is provided in the gap between the first weight 33 and the frame 50, between the first magnet 51 and the first weight 33, between the second weight 34 and the frame 50, and the gap between the third magnet 53 and the second weight 34. Consequently, the first magnet 51, the second magnet 52 and the third magnet 53 are fixed to the frame 50. Accordingly, the first magnet assembly 31 is completed. In addition, in this example, the first magnet assembly 31 is completed in a state where the first weight 33 and the second weight 34 are connected to the first magnet assembly 31.

Here, the second magnet assembly 32 can be manufactured using the same procedure as the first magnet assembly 31. In addition, by fixing the first weight 33 and the second weight 34, which have been fixed to the first magnet assembly 31, to the frame 50 of the second magnet assembly 32 that has been manufactured, the vibrating body 3 can be manufactured.

### Haptic Device

Next, a haptic device provided with the above-described vibrating motor 1 will be described. FIG. 10 is a schematic view of a haptic device. A haptic device 100 provides haptic stimulation to the operator of the haptic device 100. Examples of the haptic device 100 include a mobile phone including a smartphone, a tablet, a game device, and a wearable terminal.

The haptic device 100 includes a casing 101, the vibrating motor 1, a substrate 102 on which the vibrating motor 1 is mounted, and a controller 103. The vibrating motor 1, the substrate 102, and the controller 103 are housed inside the casing 101. The stationary body 2 of the vibrating motor 1 is electrically and mechanically connected to the substrate 102. The substrate 102 is fixed to the casing 101. The controller 103 drives and controls the vibrating motor 1. That is, the controller 103 supplies power to the coil 27 of the vibrating motor 1. More specifically, the controller 103 supplies an alternating current to the coil 27 via the substrate 102.

When an alternating current is supplied to the coil 27, the vibrating body 3 reciprocates with respect to the stationary body 2. Consequently, the vibrating motor 1 vibrates on the substrate 102 fixed to the casing 101. Thus, the haptic device 100 can provide haptic stimulation to the operator.

### Function Effect

In each of the first magnet assembly 31 and the second magnet assembly 32 of this example, the frame 50, which is made of a metal, and the first magnet 51, the second magnet 52, and the third magnet 53 are fixed to each other by welding and fixed to each other by the adhesive layer 85. Therefore, when manufacturing each of the first magnet assembly 31 and the second magnet assembly 32, first, each of the first magnet 51, the second magnet 52, and the third magnet 53 is fixed to the frame 50 by welding, and thereafter, the frame 50 and the first magnet 51, the second magnet 52, and the third magnet 53 can be fixed to each other by the adhesive layer 85. Therefore, when applying an adhesive to the frame 50 and the first magnet 51, the second magnet 52, and the third magnet 53, it is not necessary to grip and fix the frame 50 and the first magnet 51, the second magnet 52, and the third magnet 53 with a jig. Therefore, the adhesive can be prevented from adhering to the jig.

In addition, since the fixing of the frame 50 and each of the first magnet 51, the second magnet 52, and the third magnet 53 by welding is temporary fixing, it can be performed with a small amount of heat. Consequently, thermal demagnetization of each of the first magnet 51, the second magnet 52, and the third magnet 53 can be prevented or suppressed.

Furthermore, in the present example, the first welding marks 81 that welded the first magnet 51 and the frame 50 to each other are provided on either side of the opening portion 58 in the third direction Z. The second welding marks 82 that welded the second magnet 52 and the frame 50 to each other are provided on either side of the opening portion 58 in the third direction Z. The third welding marks 83 that welded the third magnet 53 and the frame 50 to each other are provided on either side of the opening portion 58 in the third direction Z. Therefore, the first magnet 51, the second magnet 52, and the third magnet 53 can be reliably fixed by welding. In addition, since each of the first magnet 51, the second magnet 52, and the third magnet 53 and the frame 50 are welded by two welding points, compared with the case where each of the first magnet 51, the second magnet 52, and the third magnet 53 and the frame 50 are welded and fixed by one welding point, the amount of heat for welding one welding point can be suppressed. Therefore, it is easy to prevent or suppress thermal demagnetization of the first magnet 51, the second magnet 52, and the third magnet 53.

Furthermore, in the present example, the frame 50 includes the opening portion 58 that extends in the first direction X over the first contact position A where the first magnet 51 and the second magnet 52 contact each other and the second contact position B where the second magnet 52 and the third magnet 53 contact each other. Therefore, by applying an adhesive to the opening portion 58, the adhesive layer 85 can be provided between the first magnet 51 and the frame 50, between the second magnet 52 and the frame 50, and between the third magnet 53 and the frame 50. In addition, by applying an adhesive to the opening portion 58, the adhesive layer 85 can be provided between the first magnet 51 and the second magnet 52 and between the second magnet 52 and the third magnet 53.

In addition, the frame 50 includes the frame main body 55 that is in contact with the first magnet 51, the second magnet 52, and the third magnet 53 from the second direction Y and the first protruding portion 56 that protrudes from the frame main body 55 in the second direction Y and comes into contact with the first magnet 51, the second magnet 52, and the third magnet 53 from the −Z direction. Furthermore, the frame 50 includes the second protruding portion 57 that protrudes from the frame main body 55 in the second direction Y and comes into contact with the first magnet 51, the second magnet 52, and the third magnet 53 from the +Z third direction. Therefore, when the frame 50 is brought into contact with the first magnet 51, the second magnet 52, and the third magnet 53, the first magnet 51, the second magnet 52 and the third magnet 53 can be easily disposed in the X direction.

### OTHER EXAMPLE EMBODIMENTS

In each of the first magnet assembly 31 and the second magnet assembly 32, the S poles of the first magnet 51, the second magnet 52, and the third magnet 53 may be disposed adjacent to each other. In this case, the first magnet 51 is disposed with the N pole oriented in the −X direction and the S pole oriented in the +X direction. The second magnet 52 is disposed with the S pole facing the coil portion 25 in the second direction Y, and the N pole facing the opposite side to the coil portion 25. The third magnet 53 is disposed with the S pole oriented in the −X direction and the N pole oriented in the +X direction. Even in this case, the vibrating body 3 can be reciprocated in the X direction by supplying an alternating current to the coil portion 25.

In addition, the vibrating motor 1 can also set the side provided with the coil portion 25 as a vibrating body, and can set the side provided with the first magnet assembly 31 and the second magnet assembly 32 as a stationary body.

Further, the present disclosure can be applied to a magnet assembly in which magnets are fixed to a metal frame regardless of the number of magnets and the arrangement of magnets.

For example, the present disclosure can be applied to a magnet assembly in which one magnet is fixed to a metal frame. In this case, the magnet assembly has a magnet provided with a nickel plating layer on the surface thereof, a metal frame contacting the magnet from a predetermined direction, and an adhesive layer provided between the frame and the magnet. The frame is provided with welding marks at positions overlapping with the magnet when viewed from a predetermined direction.

In addition, the manufacturing method of the magnet assembly having one magnet fixed to the metal frame is the same as that of the flowchart illustrated in FIG. 9. That is, a magnet provided with a nickel plating layer on the surface thereof is used as the magnet. Next, the frame and the magnet are brought into contact, and the frame and the magnet are gripped by a jig. Then, the magnet and the frame are welded to each other. Thereafter, the grip by the jig is released and the jig is separated from the magnet and the frame. After that, adhesive is applied to the magnet and the frame. Then, the adhesive is cured.

Similarly, the present disclosure can be applied to a magnet assembly including two magnets arranged with poles of the same type adjacent to each other and a metal frame contacting the two magnets from a direction intersecting the arrangement direction of the two magnets.

In this case, the magnet assembly includes a first magnet and a second magnet each provided with a nickel plating layer on the surface thereof, a metal frame contacting the first magnet and the second magnet in a direction intersecting the arrangement direction, and an adhesive layer provided between the frame and the magnets. The magnets are disposed such that N poles or S poles are adjacent to each other. The adhesive layer is provided between the first magnet and the second magnet, between the first magnet and the frame, and between the second magnet and the frame. The frame includes first welding marks at positions overlapping the first magnet and second welding marks at positions overlapping the second magnet when viewed from the direction intersecting the arrangement direction.

The method of manufacturing the magnet assembly is the same as the flowchart illustrated in FIG. 9. That is, first, magnets provided with a nickel plating layer on the surface thereof are prepared as a first magnet and a second magnet. Next, the first magnet and the second magnet are brought into contact with a frame, and the frame and the magnets are gripped by a jig. Then, welding of the first magnet and the frame and welding of the second magnet and the frame are performed. Thereafter, the grip by the jig is released to separate the jig from the first magnet, the second magnet and the frame. Thereafter, an adhesive is applied to the first magnet, the second magnet, and the frame. Then, the adhesive is cured.

Here, the first magnet and the second magnet in which poles of the same type are arranged adjacent to each other repel each other. Therefore, unless the two magnets and the frame are gripped by the jig, it is not possible to bring both the first magnet and the second magnet into contact with the frame. Therefore, in the method of manufacturing the magnet assembly, first, the first magnet, the second magnet, and the frame are gripped by a jig and welded to each other. In this way, the first magnet, the second magnet and the frame are temporarily fixed to each other. After that, the grip by the jig is released, and the first magnet, the second magnet, and the frame are fixed to each other with an adhesive. In this way, adhesion of the adhesive to the jig can be avoided.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A method of manufacturing a magnet assembly in which a magnet is fixed to a frame made of a metal, the method comprising:
using a magnet including a plating layer on a surface thereof as the magnet;
bringing the frame and the magnet into contact with each other and gripping the frame and the magnet with a jig;
welding the magnet and the frame to each other;
releasing the grip of the jig to separate the jig from the magnet and the frame; and
applying an adhesive to the magnet and the frame.

2. A method of manufacturing a magnet assembly in which a first magnet, a second magnet, and a third magnet are fixed to a frame made of a metal, the method comprising:
using magnets including a plating layer on a surface thereof as the first magnet, the second magnet, and the third magnet;
disposing the first magnet, the second magnet, and the third magnet in a first direction determined in advance with same poles being adjacent to each other;
bringing the frame into contact with the first magnet, the second magnet, and the third magnet from a second direction intersecting the first direction and gripping the frame, the first magnet, the second magnet, and the third magnet with a jig;
welding the first magnet and the frame to each other, welding the second magnet and the frame to each other, and welding the third magnet and the frame to each other;
releasing the grip of the jig to separate the jig from the first magnet, the second magnet, the third magnet, and the frame; and
applying an adhesive to the first magnet, the second magnet, the third magnet, and the frame.

3. A magnet assembly comprising:
a magnet;
a frame that is made of a metal and that contacts the magnet from a predetermined direction; and
an adhesive layer provided between the frame and the magnet; wherein
the magnet includes a plating layer on a surface of the magnet; and
the frame is provided with a welding mark at a position overlapping the magnet when viewed from the predetermined direction.

4. A magnet assembly comprising:
a first magnet, a second magnet, and a third magnet disposed in a first direction determined in advance;
a frame that is made of a metal and that contacts the first magnet, the second magnet, and the third magnet from a second direction intersecting the first direction; and
an adhesive layer provided between the first magnet and the frame, between the second magnet and the frame, and between the third magnet and the frame; wherein
each of the first magnet, the second magnet, and the third magnet includes a plating layer on a surface of the first magnet, the second magnet, and the third magnet,
same poles of the first magnet, the second magnet, and the third magnet are adjacent to each other; and
the frame includes, when viewed from the second direction, a first welding mark at a position overlapping the first magnet, a second welding mark at a position overlapping the second magnet, and a third welding mark at a position overlapping the third magnet.

5. The magnet assembly according to claim 4, wherein the frame includes an opening portion that extends in the first direction over a first contact position where the first magnet and the second magnet contact each other and a second contact position where the second magnet and the third magnet contact each other.

6. The magnet assembly according to claim 5, wherein
the first welding mark is provided on either side of the opening portion in a third direction intersecting the first direction and the second direction;
the second welding mark is provided on either side of the opening portion in the third direction; and
the third welding mark is provided on either side of the opening portion in the third direction.

7. The magnet assembly according to claim 5, wherein
the frame includes a frame main body that contacts the first magnet, the second magnet, and the third magnet from the second direction, and a protruding portion that protrudes from the frame main body in the second direction and contacts the first magnet, the second magnet, and the third magnet from a third direction intersecting the first direction and the second direction; and
the first welding mark, the second welding mark, and the third welding mark are provided on the frame main body.

8. A vibrating motor comprising:
the magnet assembly according to claim 3; and
a coil disposed inside a magnetic field generated by the magnet assembly; wherein
one of the magnet assembly and the coil is moved by supplying power to the coil.

9. A vibrating motor comprising:
the magnet assembly according to claim 4; and
a coil disposed inside a magnetic field generated by the magnet assembly; wherein
one of the magnet assembly and the coil is moved by supplying power to the coil.

10. A vibrating motor comprising:
the magnet assembly according to claim 5; and
a coil disposed inside a magnetic field generated by the magnet assembly; wherein
one of the magnet assembly and the coil is moved by supplying power to the coil.

11. A vibrating motor comprising:
the magnet assembly according to claim 6; and
a coil disposed inside a magnetic field generated by the magnet assembly; wherein
one of the magnet assembly and the coil is moved by supplying power to the coil.

12. A haptic device comprising:
the vibrating motor according to claim 8; and
a controller that supplies power to the coil of the vibrating motor.
